(19) United States
(12) Patent Application Publication
(10) Pub. No.: US 2018/0093409 A1
(43) Pub. Date: Apr. 5, 2018

(54) STRETCHED FILM MANUFACTURING METHOD AND STRETCHED FILM

(71) Applicant: ZEON CORPORATION, Chiyoda-ku, Tokyo (JP)

(72) Inventor: Takao KOBAYASHI, Tokyo (JP)

(73) Assignee: ZEON CORPORATION, Chiyoda-ku, Tokyo (JP)

(21) Appl. No.: 15/559,917

(22) PCT Filed: Mar. 14, 2016
(86) PCT No.: PCT/JP2016/058014

§ 371 Date: Sep. 20, 2017

(30) Foreign Application Priority Data
Mar. 31, 2015 (JP) 2015-073062

(51) Int. Cl. B29C 55/08; B29C 55/20; B29C 71/02; C08J 5/18; G02B 5/30

(52) U.S. Cl. CPC B29C 55/08; B29C 55/20; B29L 2007/00; C08J 5/18; G02B 5/305; B29C 71/02

(57) ABSTRACT

A method for manufacturing a stretched film, including stretching a long-length resin film in an oven by grippers while conveying the resin film to pass the resin film through the oven to manufacture a long-length stretched film having a slow axis within an average angle range of 10° or more and 80° or less with respect to a width direction thereof, wherein the oven has a stretching zone and a heat setting zone in this order from an upstream side, and the method includes the steps of: holding the both edges of the resin film by the grippers; stretching the resin film in the stretching zone; releasing the resin film from the grippers in the heat setting zone; and subjecting the resin film released from the grippers to a heat treatment at a temperature higher than Tg−10° C. and lower than Tg for 10 seconds or more in the heat setting zone.

### FIELD

The present invention relates to a method for manufacturing a stretched film and a stretched film.

### BACKGROUND

When a long-length stretched film is manufactured by stretching a long-length resin film, a tenter stretching machine may be used. Usually, a manufacturing method using the tenter stretching machine involves stretching the long-length resin film during conveyance to continuously obtain a long-length stretched film. Such a stretched film may cause size change due to thermal shrinkage when heated. Thus, various technologies have been developed in prior art to suppress such thermal shrinkage as described above (see Patent Literatures 1 to 4).

### CITATION LIST

### Patent Literature

Patent Literature 1: Japanese Patent Application Laid-Open No. Sho. 51-46372 A

Patent Literature 2: Japanese Patent No. 2999379 B

Patent Literature 3: Japanese Patent No. 4400707 B

Patent Literature 4: Japanese Patent Application Laid-Open No. 2014-194483 A (corresponding foreign publication: European Patent Application Publication No. 2980613)

### SUMMARY

### Technical Problem

In a stretched film, polymer molecules included in the stretched film are usually oriented in the stretching direction. Consequently, the aforementioned stretched film usually has a slow axis in a direction either parallel or perpendicular to the stretching direction. Thermal shrinkage tends to occur in a large degree in a direction in which the molecules are oriented, and therefore particularly large thermal shrinkage may generally occur in the stretched film in a direction parallel or perpendicular to the slow axis direction.

Usually, a stretched film has a retardation resulting from stretching. Therefore, the stretched film may be used as a phase difference film having a retardation. It is desirable that the stretched film to be used as a phase difference film as described above has a slow axis in a diagonal direction, which is neither parallel nor perpendicular to the width direction of the stretched film, in order to facilitate adjustment of an optical axis when the phase difference film is combined with any other optical member. Therefore, in recent years, from the viewpoint of efficient manufacture of the stretched film having a slow axis in a diagonal direction as described above, attention has been focused on a diagonally-stretched film which is manufactured by stretching a resin film in a diagonal direction.

However, in the diagonally-stretched film, particularly large thermal shrinkage is likely to occur in a diagonal direction and it was difficult to achieve adequate suppression of thermal shrinkage by using prior art technologies described in Patent Literatures 1 to 4. In particular, the methods described in Patent Literatures 1 to 3, in some cases, led to large thermal shrinkage, thereby impairing the planarity of the stretched film and generating wrinkles.

The present invention has been created in view of the aforementioned problems. It is an object of the present invention to provide a method for manufacturing a stretched film which has a slow axis in a diagonal direction, has excellent planarity, and has suppressed thermal shrinkage; and a stretched film which has a slow axis in a diagonal direction, has excellent planarity, and has suppressed thermal shrinkage.

### Solution to Problem

To solve the aforementioned problems, the present inventor has studied a manufacturing method for manufacturing a stretched film including stretching a resin film in a diagonal direction by using grippers in an oven. As a result, the present inventor has found out that thermal shrinkage can be effectively suppressed while suppressing generation of wrinkles by releasing the resin film from the grippers in the oven after stretching and subjecting the released resin film to a specific heat treatment in the oven, and accomplished the present invention.

Specifically, the present invention is as follows.

(1) A method for manufacturing a stretched film, including stretching a long-length resin film in an oven by grippers holding both edges of the resin film while conveying the resin film to pass the resin film through the oven to manufacture a long-length stretched film having a slow axis within an average angle range of 10° or more and 80° or less with respect to a width direction thereof, wherein

the oven has a stretching zone and a heat setting zone in this order from an upstream side, and

the method comprises the steps of:

holding the both edges of the resin film by the grippers;

stretching the resin film in the stretching zone;

releasing the resin film from the grippers in the heat setting zone; and

subjecting the resin film released from the grippers to a heat treatment at a temperature higher than Tg−10° C. and lower than Tg (Tg represents a glass transition temperature of a resin for forming the resin film) for 10 seconds or more in the heat setting zone.

(2) The method for manufacturing a stretched film according to (1), wherein a conveyance tension for the resin film in the step of subjecting the resin film to the heat treatment is 100 N/cm² or more and 300 N/cm² or less.

(3) A long-length stretched film formed of a thermoplastic resin, wherein

the long-length stretched film has a slow axis within an average angle range of 10° or more and 80° or less with respect to a width direction of the stretched film, and

a thermal shrinkage rate in a direction of the slow axis when the stretched film is kept at Tg−18° C. (Tg represents a glass transition temperature of the thermoplastic resin) for one hour is 0.1% to 0.3%.

(4) The long-length stretched film according to (3), having a thickness of 10 μm to 50 μm.

### Advantageous Effects of Invention

The present invention can provide a method for manufacturing a stretched film which has a slow axis in a diagonal direction, has excellent planarity, and has suppressed thermal shrinkage; and a stretched film which has a slow axis in a diagonal direction, has excellent planarity, and has suppressed thermal shrinkage.

### BRIEF DESCRIPTION OF DRAWINGS

FIG. 1 is a plan view schematically showing an apparatus for manufacturing a stretched film according to a first embodiment of the present invention.

FIG. 2 is a plan view schematically showing a tenter unit and a trimming unit according to the first embodiment of the present invention.

FIG. 3 is a side view schematically showing the downstream part of the apparatus for manufacturing a stretched film according to the first embodiment of the present invention.

FIG. 4 is a plan view schematically showing an apparatus for manufacturing a stretched film according to a second embodiment of the present invention.

FIG. 5 is a plan view schematically showing a tenter unit according to the second embodiment of the present invention.

FIG. 6 is a plan view schematically showing a test piece used for measuring a thermal shrinkage rate.

### DESCRIPTION OF EMBODIMENTS

Hereinafter, the present invention will be described in detail with reference to embodiments and examples. However, the present invention is not limited to the following embodiments and examples, and may be freely modified and practiced without departing from the scope of claims of the present invention and the scope of their equivalents.

In the following description, a “long-length” film refers to a film with the length being at least 5 or more times the width, and preferably a film with the length being 10 or more times the width. Specifically, the “long-length” film refers to a film long enough to be wound up into a roll form and stored or transported. The upper limit of the ratio of the length relative to the width of the film is not particularly limited, and may be, for example, 100,000 times or lower.

In the following description, “upstream” and “downstream” refer to the upstream and the downstream in a conveying direction of a film, respectively, unless otherwise stated.

In the following description, an in-plane retardation of a film represents a value expressed by (nx−ny)×d, unless otherwise stated. In this formula, nx represents a refractive index in a direction that gives the maximum refractive index among the directions which are perpendicular to the thickness direction (in-plane directions) of the film. ny represents a refractive index in a direction that is orthogonal to the direction of nx among the aforementioned in-plane directions of the film. d represents the thickness of the film. The measuring wavelength is 590 nm unless otherwise stated.

In the following description, the term “(meth)acryl-” encompasses “acryl-” and “methacryl-”.

In the following description, when a direction of an element is expressed as being “parallel”, “perpendicular”, or “orthogonal”, the direction may have an error to the extent which does not impair the effect of the present invention, for example, an error of ±5°, unless otherwise stated.

In the following description, a diagonal direction of a long-length film represents an in-plane direction of the film which is neither parallel nor perpendicular to the width direction of the film, unless otherwise stated.

In the following description, the terms “polarizing plate” and “wave plate” encompass not only a rigid member but also a flexible member such as a resin film, unless otherwise stated.

### 1. First Embodiment

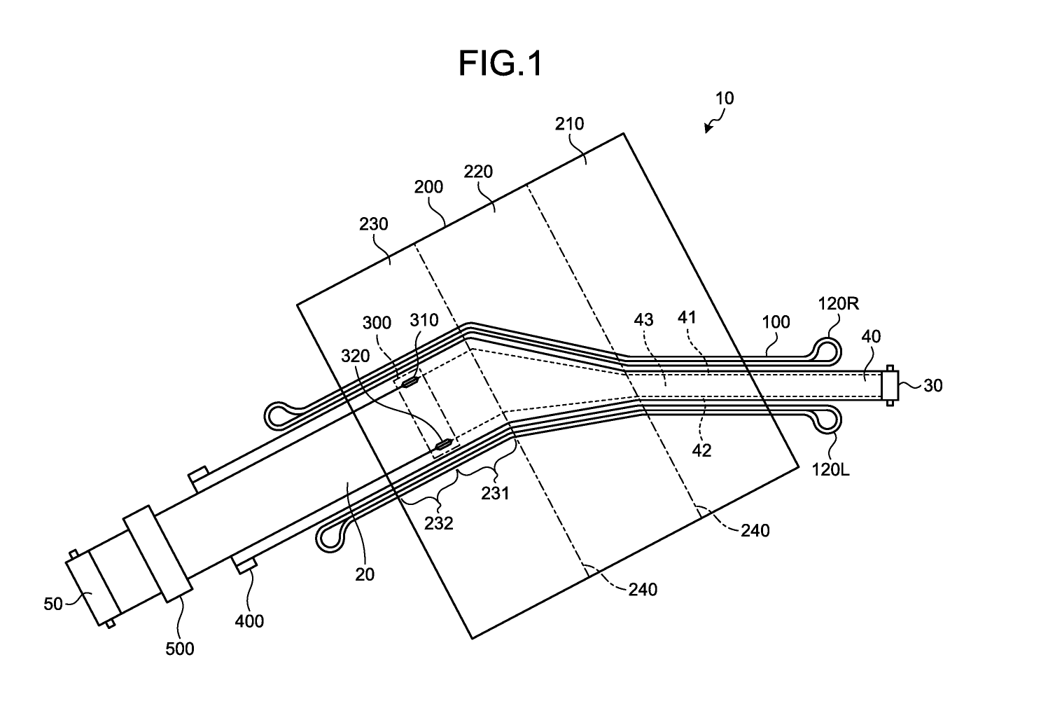

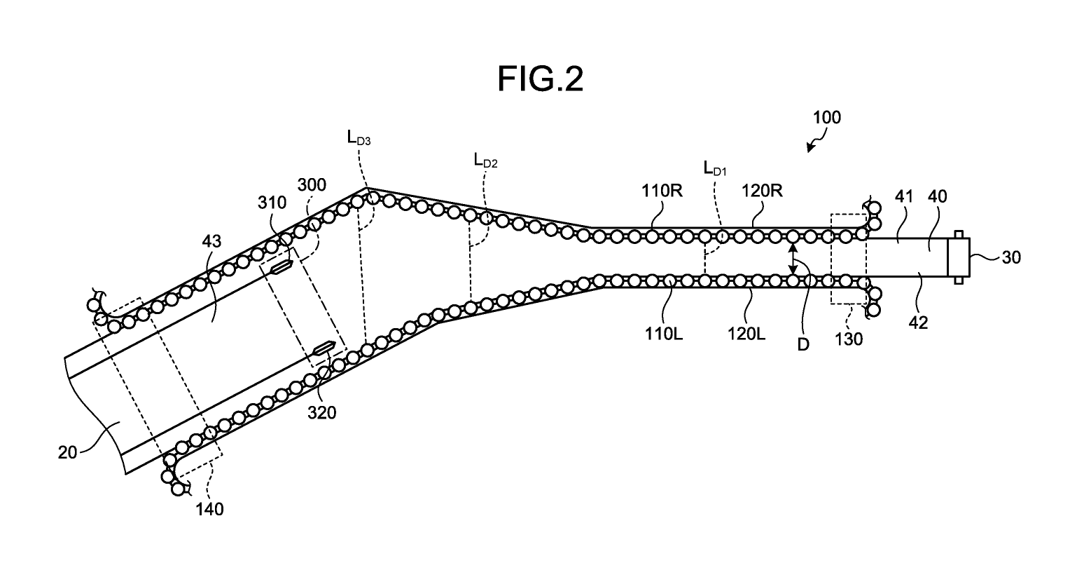

FIG. 1 is a plan view schematically showing an apparatus 10 for manufacturing a stretched film 20 according to a first embodiment of the present invention. In FIG. 1, outside grippers 110R and inside grippers 110L in a tenter unit 100 are not shown. FIG. 2 is a plan view schematically showing the tenter unit 100 and a trimming unit 300 according to the first embodiment of the present invention.

As shown in FIG. 1, the apparatus 10 for manufacturing the stretched film 20 according to the first embodiment of the present invention includes the tenter unit 100 serving as a stretching unit, an oven 200 serving as a temperature control unit, the trimming unit 300 serving as a releasing device, a conveying roll 400, and a take-up unit 500 serving as a tension control device. This manufacturing apparatus 10 is configured to be able to manufacture the stretched film 20 by feeding a resin film 40 from a feeding roll 30 and stretching the fed resin film 40 in the oven 200 by using the tenter unit 100.

Furthermore, the manufacturing apparatus 10 does not process the entire stretched resin film 40 into the stretched film 20. The manufacturing apparatus 10 is configured to trim off unnecessary areas, that is, both edges 41 and 42 in the width direction, from the stretched resin film 40 to obtain the stretched film 20 from the resin film corresponding to a remaining middle part 43. In FIG. 1, borders between the middle part 43 and both edges 41 and 42 of the resin film 40 are illustrated by a broken line. In the following description, the resin film obtained by trimming off both edges 41 and 42 from the stretched resin film 40 may be appropriately referred to as “remaining resin film” in order to distinguish the resin film thus obtained from the resin film 40 before trimming off. Furthermore, this remaining resin film corresponds to the middle part 43 of the resin film 40 before trimming off, and therefore is denoted by the same reference numeral “43” as the aforementioned middle part 43 for description.

[1.1. Resin Film 40]

A thermoplastic resin is usually used as a resin forming the resin film 40. Examples of such a thermoplastic resin may include a polyolefin resin such as a polyethylene resin and a polypropylene resin; an alicyclic structure-containing polymer resin such as a norbornene resin; a cellulose-based resin such as a diacetylcellulose resin and a triacetylcellulose resin; a polyimide resin; a polyamideimide resin; a polyamide resin; a polyetherimide resin; a polyether ether ketone resin; a polyether ketone resin; a polyketone sulfide resin; a polyether sulfone resin; a polysulfone resin; a polyphenylene sulfide resin; a polyphenylene oxide resin; a polyethylene terephthalate resin; a polybutylene terephthalate resin; a polyethylene naphthalate resin; a polyacetal resin; a polycarbonate resin; a polyarylate resin; a (meth)acrylic resin; a polyvinyl alcohol resin; a polypropylene resin; a cellulose-based resin; an epoxy resin; a phenol resin; a copolymer resin of a (meth)acrylic acid ester and a vinyl aromatic compound; a copolymer resin of isobutene and N-methylmaleimide; and a copolymer resin of styrene and acrylonitrile. One type thereof may be solely used, and two or more types thereof may also be used in combination at any ratio.

Among the aforementioned thermoplastic resins, the alicyclic structure-containing polymer resin is preferable. The alicyclic structure-containing polymer resin is a resin containing an alicyclic structure-containing polymer and has excellent characteristics such as transparency, low hygroscopicity, size stability, and lightweight properties.

The alicyclic structure-containing polymer is a polymer having an alicyclic structure in the structural unit of the polymer. Both a polymer having an alicyclic structure in the main chain and a polymer having an alicyclic structure in the side chain may be used. As the alicyclic structure-containing polymer, one type thereof may be solely used, and two or more types thereof may also be used in combination at any ratio. Among these, the polymer having an alicyclic structure in the main chain is preferable in terms of mechanical strength and heat resistance.

Examples of the alicyclic structure may include a saturated alicyclic hydrocarbon (cycloalkane) structure, and an unsaturated alicyclic hydrocarbon (cycloalkene, cycloalkyne) structure. Among these, from the viewpoint of mechanical strength and heat resistance, a cycloalkane structure and a cycloalkene structure are preferable, and a cycloalkane structure is particularly preferable.

The number of carbon atoms which constitute the alicyclic structure is, per one alicyclic structure, preferably 4 or more, and more preferably 5 or more, and is preferably 30 or less, more preferably 20 or less, and particularly preferably 15 or less. When the number of carbon atoms which constitute the alicyclic structure falls within this range, mechanical strength, heat resistance, and molding properties of the resin including the alicyclic structure-containing polymer can be highly balanced, and thus preferable.

The ratio of the structural units having an alicyclic structure in the alicyclic structure-containing polymer may be appropriately selected depending on the purpose of use, and is preferably 55% by weight or more, more preferably 70% by weight or more, and particularly preferably 90% by weight or more. When the ratio of the structural units having an alicyclic structure in the alicyclic structure-containing polymer falls within this range, the resin including the alicyclic structure-containing polymer has a favorable transparency and heat resistance.

Examples of the alicyclic structure-containing polymer may include a norbornene polymer, a monocyclic olefin polymer, a cyclic conjugated diene polymer, a vinyl alicyclic hydrocarbon polymer, and hydrogenated products thereof. Among these, since favorable transparency and molding properties can be obtained, a norbornene polymer is more preferable.

Examples of the norbornene polymer may include: a ring-opened polymer of a monomer having a norbornene structure and a hydrogenated product thereof; and an addition polymer of a monomer having a norbornene structure and a hydrogenated product thereof. Examples of the ring-opened polymer of a monomer having a norbornene structure may include a ring-opened homopolymer of one type of monomer having a norbornene structure, a ring-opened copolymer of two or more types of monomers each having a norbornene structure, and a ring-opened copolymer of a monomer having a norbornene structure and an optional monomer which is copolymerizable with the monomer having a norbornene structure. Furthermore, examples of the addition polymer of a monomer having a norbornene structure may include an addition homopolymer of one type of monomer having a norbornene structure, an addition copolymer of two or more types of monomers each having a norbornene structure, and an addition copolymer of a monomer having a norbornene structure and an optional monomer which is copolymerizable with the monomer having a norbornene structure. Among these, a hydrogenated product of a ring-opened polymer of a monomer having a norbornene structure is particularly suitable from the viewpoint of transparency, molding properties, heat resistance, low hygroscopicity, size stability, lightweight properties, and the like.

Examples of the monomer having a norbornene structure may include bicyclo[2.2.1]hept-2-ene (common name: norbornene), tricyclo[4.3.0.1^{2,5}]dec-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodeca-3-ene (common name: tetracyclododecene), and derivatives of these compounds (for example, a derivative having a substituent on the ring). Examples of the substituent herein may include an alkyl group, an alkylene group, and a polar group. A plurality of the substituents, which are the same as or different from each other, may be bonded on the ring. As the monomer having a norbornene structure, one type thereof may be solely used, and two or more types thereof may also be used in combination at any ratio.

Examples of the type of the polar group may include a hetero atom, or an atomic group having a hetero atom. Examples of the hetero atom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of the optional monomer which is ring-opening copolymerizable with the monomer having a norbornene structure may include: monocyclic olefins such as cyclohexene, cycloheptene, cyclooctene, and derivatives thereof; and cyclic conjugated dienes such as cyclohexadiene and cycloheptadiene, and derivatives thereof.

As the optional monomer which is ring-opening copolymerizable with the monomer having a norbornene structure, one type thereof may be solely used, and two or more types thereof may also be used in combination at any ratio.

The ring-opened polymer of a monomer having a norbornene structure may be manufactured by, for example, the polymerization or copolymerization of a monomer in the presence of a known ring-opening polymerization catalyst.

Examples of the optional monomer which is addition copolymerizable with the monomer having a norbornene structure may include: α-olefins of 2 to 20 carbon atoms such as ethylene, propylene, and 1-butene, and derivatives thereof; cycloolefins such as cyclobutene, cyclopentene and cyclohexene, and derivatives thereof; and non-conjugated dienes such as 1,4-hexadiene, 4-methyl-1,4-hexadiene, and 5-methyl-1,4-hexadiene. Among these, α-olefin is preferable, and ethylene is more preferable. As the optional monomer which is addition copolymerizable with the monomer having a norbornene structure, one type thereof may be solely used, and two or more types thereof may also be used in combination at any ratio.

The addition polymer of a monomer having a norbornene structure may be manufactured by, for example, the polymerization or copolymerization of a monomer in the presence of a known addition polymerization catalyst.

The hydrogenated product of the ring-opened polymer or the addition polymer described above may be manufactured by, for example, hydrogenating preferably 90% or more of unsaturated carbon-carbon bonds in a solution of the ring-opened polymer or the addition polymer, in the presence of a hydrogenation catalyst which contains transition metal such as nickel and palladium.

Preferably, the norbornene polymer has, as a structural unit, X: a bicyclo[3.3.0]octane-2,4-diyl-ethylene structure, and Y: a tricyclo[4.3.0.1^{2,5}]decane-7,9-diyl-ethylene structure, wherein the norbornene polymer contains these structural units in an amount of 90% by weight or more relative to the entire structural units of the norbornene polymer, and the ratio between the proportion of X and the proportion of Y is 100:0 to 40:60 in terms of the weight ratio of X:Y. The use of such a polymer enables the stretched film 20 to show no changes in size in a long period of time and to become excellent in stability of characteristics.

The weight-average molecular weight (Mw) of the polymer included in the resin forming the resin film 40 is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within such a range, mechanical strength and molding processability of the stretched film 20 can be highly balanced, and thus preferable. The weight-average molecular weight described above is a weight-average molecular weight of polyisoprene or polystyrene equivalent measured by gel permeation chromatography with cyclohexane as a solvent. However, when a sample is not dissolved in cyclohexane in the aforementioned gel permeation chromatography, toluene may be used as the solvent.

The molecular weight distribution (weight-average molecular weight (Mw)/number-average molecular weight (Mn)) of the polymer included in the resin forming the resin film 40 is preferably 1.2 or more, more preferably 1.5 or more, and particularly preferably 1.8 or more, and is preferably 3.5 or less, more preferably 3.0 or less, and particularly preferably 2.7 or less. When the molecular weight distribution is equal to or more than the lower limit value of the aforementioned range, productivity of the polymer can be enhanced, and manufacturing costs can thereby be reduced. When the molecular weight distribution is equal to or less than the upper limit value, the amount of a low-molecular component is reduced. This can suppress relaxation during exposure to high temperature to enhance the stability of the stretched film 20.

The ratio of the polymer in the resin forming the resin film 40 is preferably 50% by weight to 100% by weight, and more preferably 70% by weight to 100% by weight. In particular, when the alicyclic structure-containing polymer resin is used as the resin, the ratio of the alicyclic structure-containing polymers included in the alicyclic structure-containing polymer resin is preferably 80% by weight to 100% by weight, and more preferably 90% by weight to 100% by weight.

The resin forming the resin film 40 may also include an optional component in addition to polymers. Examples of the optional component may include additives, such as a colorant such as a pigment or a dye; a plasticizer; a fluorescent brightening agent; a dispersing agent; a heat stabilizer; a light stabilizer; an ultraviolet ray absorber; an antistatic agent; an antioxidant; fine particles; and a surfactant. One type these components may be solely used, and two or more types thereof may also be used in combination at any ratio. However, the amount of the polymer included in the resin is preferably 50% by weight to 100% by weight, or 70% by weight to 100% by weight.

The glass transition temperature Tg of the resin forming the resin film 40 is preferably 100° C. or higher, more preferably 110° C. or higher, and particularly preferably 120° C. or higher, and is preferably 200° C. or lower, more preferably 190° C. or lower, and particularly preferably 180° C. or lower. When the glass transition temperature of the resin is equal to or higher than the lower limit value of the aforementioned range, durability of the stretched film 20 in a high-temperature environment can be increased. On the other hand, when the glass transition temperature of the resin is equal to or lower than the upper limit value of the aforementioned range, the stretching process can be easily performed.

The absolute value of a photoelastic coefficient C of the resin forming the resin film 40 is preferably 10×10⁻¹² Pa⁻¹ or less, more preferably 7×10⁻¹² Pa⁻¹ or less, and particularly preferably 4×10⁻¹² Pa⁻¹ or less. Use of the resin having this property can reduce fluctuation of the in-plane retardation of the stretched film 20. As described herein, the photoelastic coefficient C is a value expressed by C=Δn/σ, where Δn is birefringence and σ is stress. The lower limit of the photoelastic coefficient of a hydrocarbon polymer is not particularly limited, and may be 1×10⁻¹³ Pa⁻¹ or more.

This embodiment will be described by illustrating an example using an unstretched film as the resin film 40, the unstretched film having not been subjected to a stretching process. Such an unstretched film may be obtained by a cast molding method, an extrusion molding method, and inflation molding method, or the like. The extrusion molding method is preferable among these because the resulting film contains a small quantity of residual volatile components and has excellent size stability.

[1.2. Tenter Unit 100]

As shown in FIG. 1, the tenter unit 100 is a device for stretching the resin film 40 fed from the feeding roll 30. As shown in FIG. 2, this tenter unit 100 includes the outside grippers 110R as first grippers and the inside grippers 110L as second grippers, and a pair of guide rails 120R and 120L. The outside grippers 110R and the inside grippers 110L are provided in such a manner that they can hold the resin film 40 at the edges 41 and 42, respectively. The guide rails 120R and 120L are provided on respective sides of a film-conveying path to guide the aforementioned outside grippers 110R and inside grippers 110L.

The outside grippers 110R are provided in such a manner that it can run along the guide rail 120R provided on the right side of the film-conveying path. The inside grippers 110L are provided in such a manner that it can run along the guide rail 120L provided on the left side of the film-conveying path. In this embodiment, “right” and “left” refer to directions as observed from upstream to downstream of the conveying direction of the film when the film is conveyed horizontally as shown in FIGS. 1 to 5, unless otherwise stated.

These outside grippers 110R and inside grippers 110L are both provided in large numbers. Furthermore, the outside grippers 110R and the inside grippers 110L are provided in such a manner that each gripper can run at a constant speed keeping a constant distance with upstream and downstream ones of the outside grippers 110R and the inside grippers 110L.

Furthermore, the outside grippers 110R and the inside grippers 110L are provided in such a manner that they can hold respective edges 41 and 42 in the width direction of the resin film 40, which is sequentially fed into the tenter unit 100, at an inlet 130 of the tenter unit 100 and release these edges at an outlet 140 of the tenter unit 100.

The guide rails 120R and 120L have an endless continuous orbit as shown in FIG. 1 in such a manner that the outside grippers 110R and the inside grippers 110L can go around given orbits. Thus, the tenter unit 100 has a configuration which can sequentially return the outside grippers 110R and inside grippers 110L to the inlet 130 after the grippers released the resin film 40 at the outlet 140 of the tenter unit 100.

The guide rails 120R and 120L have asymmetrical shapes in conformity with requirements such as the direction of the slow axis and the stretching ratio of the stretched film 20 to be manufactured. In this embodiment, the shape of the guide rails 120R and 120L is designed in such a manner that the resin film 40 can be conveyed in a specific manner. Thereby, the guide rails 120R and 120L can convey the resin film 40 in such a manner that the outside grippers 110R and the inside grippers 110L guided by the guide rails 120R and 120L bend the moving direction of the resin film 40 leftward. The moving direction of the resin film 40 herein refers to a direction along which the middle point in the width direction of the resin film 40 moves.

As described above, the shape of the guide rails 120R and 120L is designed in such a manner that the moving direction of the resin film 40 is bent leftward. Therefore, while the outside grippers 110R and the inside grippers 110L oppose to each other in the direction perpendicular to the moving direction of the resin film 40 at the inlet 130 of the tenter unit 100, the inside grippers 110L can precede the outside grippers 110R after stretching the resin film 40. With this configuration, the tenter unit 100 can stretch the resin film 40 in a diagonal direction of the resin film 40 (see the broken line L_{D1} to L_{D3} in FIG. 2).

[1.3. Oven 200]

As shown in FIG. 1, the manufacturing apparatus 10 includes the oven 200 provided so as to cover the film-conveying path. This oven 200 is provided so as to cover the tenter unit 100, such that the tenter unit 100 can stretch the resin film 40 which is conveyed to pass through the oven 200.

The oven 200 includes a preheating zone 210, a stretching zone 220, and a heat setting zone 230 in this order from the upstream side of the conveying direction of the film. The oven 200 includes partitions 240 which can separate the preheating zone 210, the stretching zone 220, and the heat setting zone 230, so that the temperatures in the preheating zone 210, the stretching zone 220, and the heat setting zone 230 can be controlled independently. Furthermore, this partition 240 has an opening for passing the resin film 40 therethrough (not shown) in a part corresponding to the film-conveying path, so that the resin film 40 can move in the oven 200.

The preheating zone 210 is a compartment provided upstream of the stretching zone 220 and is usually provided immediately after the inlet of the oven 200. Usually, the preheating zone 210 is provided in such a manner that the outside grippers 110R and the inside grippers 110L which hold respective edges 41 and 42 of the resin film 40 can run while keeping a constant distance D (see FIG. 2). The temperature of the preheating zone 210 is set in such a manner that the resin film 40 can be heated to a desired preheating temperature.

In measuring the temperature of the resin film 40 during conveyance, the resin film 40 may be damaged when a temperature sensor is in contact with the resin film 40. Therefore, in this embodiment, the temperature of a space within a 5 mm distance from an area to be measured of the resin film 40 may be measured and adopted as the temperature of the area to be measured of the resin film 40.

As shown in FIG. 1, the stretching zone 220 is a compartment starting where the distance between the outside grippers 110R and the inside grippers 110L which hold respective edges 41 and 42 of the resin film 40 starts to become wider and ending where the distance becomes constant again. In the stretching zone 220, the shapes of the guide rails 120R and 120L are designed in such a manner that the distance between the outside grippers 110R and the inside grippers 110L becomes wider towards a downstream direction. As described above, in this embodiment, the shapes of the guide rails 120R and 120L are also designed so as to bend the moving direction of the resin film 40 leftward. Therefore, in this stretching zone 220, the moving distance of the outside grippers 110R are set to be longer than the moving distance of the inside grippers 110L. Usually, the temperature of this stretching zone 220 is set in such a manner that the resin film 40 can be heated to a desired stretching temperature.

The heat setting zone 230 is a compartment provided downstream of the stretching zone 220. The trimming unit 300 is provided in this heat setting zone 230. Furthermore, an area 231 upstream of the trimming unit 300 in the heat setting zone 230 is usually provided in such a manner that the outside grippers 110R and the inside grippers 110L which hold respective edges 41 and 42 of the resin film 40 can run while keeping a constant distance D. However, the trimming unit 300 may be provided immediately after the stretching zone 220, and therefore the heat setting zone 230 may not include the area 231 upstream of the trimming unit 300. The temperature of the heat setting zone 230 is set in such a manner that the remaining resin film 43 which is conveyed in an area 232 downstream of the trimming unit 300 in the heat setting zone 230 may be heated at a specific heat treatment temperature.

[1.4. Trimming Unit 300]

As shown in FIG. 1, the manufacturing apparatus 10 includes the trimming unit 300 in the heat setting zone 230 of the oven 200 as a releasing device for releasing the remaining resin film 43 from the outside grippers 110R and the inside grippers 110L.

The trimming unit 300 includes trimming knives 310 and 320 which can cut the conveyed resin film 40 continuously in the longitudinal direction. The trimming knives 310 and 320 are provided at the border between the middle part 43 of the resin film 40 and the edges 41 and 42 so that the knives can cut the resin film 40 on the inside of the edges 41 and 42. Accordingly, the trimming unit 300 is provided in such a manner that it can release the remaining resin film 43 from the outside grippers 110R and the inside grippers 110L within the heat setting zone 230 by cutting the resin film 40 with the trimming knives 310 and 320.

[1.5. Conveying Roll 400]

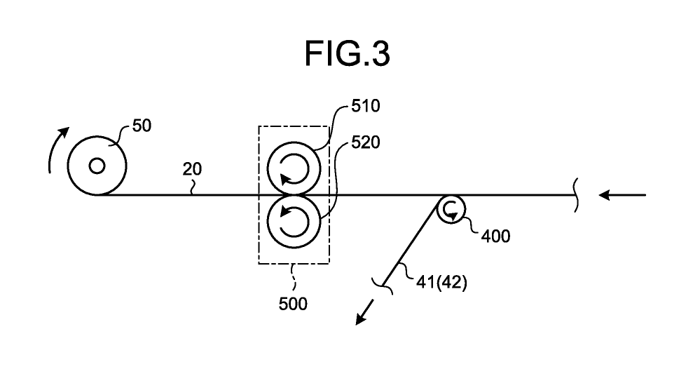

FIG. 3 is a side view schematically showing the downstream part of the apparatus 10 for manufacturing the stretched film 20 according to the first embodiment of the present invention.

As shown in FIG. 3, the manufacturing apparatus 10 includes the conveying roll 400 downstream of the oven 200. The conveying roll 400 is provided in such a manner that both edges 41 and 42 which were trimmed off from the resin film 40 with the trimming knives 310 and 320 can be guided to a place different from that for the stretched film 20 and collected.

[1.6. Take-up Unit 500]

As shown in FIG. 3, the manufacturing apparatus 10 includes the take-up unit 500 downstream of the oven 200 for taking up the stretched film 20. The take-up unit 500 includes a pair of take-up rolls 510 and 520 provided to oppose each other. These take-up rolls 510 and 520 are provided in such a manner that the stretched film 20 which was passed between the take-up rolls 510 and 520 can be taken up with a specific conveyance tension. Thus, the take-up unit 500 is provided in such a manner that it can apply the specific conveyance tension to the stretched film 20 and furthermore apply the specific conveyance tension to the remaining resin film 43 connecting to the aforementioned the stretched film 20.

[1.7 Method for Manufacturing Stretched Film 20]

When the stretched film 20 is manufactured by using the aforementioned manufacturing apparatus 10, a manufacturing method is performed, the method including, in this order, the steps of: holding respective edges 41 and 42 of the resin film 40 by the outside grippers 110R and the inside grippers 110L; stretching the resin film 40 in the stretching zone 220; releasing the resin film 40 from the outside grippers 110R and the inside grippers 110L in the heat setting zone 230; and heat-treating the middle part 43 of the resin film released from the outside grippers 110R and the inside grippers 110L in the heat setting zone 230. In this manufacturing method, the aforementioned steps are performed while the resin film 40 is conveyed to pass through the oven 200. Specifically, this manufacturing method is carried out as described below.

As shown in FIG. 1, this manufacturing method performs the steps of feeding the long-length resin film 40 from the feeding roll 30 and continuously supplying the fed resin film 40 to the tenter unit 100.

As shown in FIG. 2, after the resin film 40 is supplied to the tenter unit 100, the tenter unit 100 performs the step of holding respective edges 41 and 42 of the resin film 40 sequentially by the outside grippers 110R and the inside grippers 110L at the inlet 130 of the tenter unit 100. Then, the tenter stretching unit 100 conveys the resin film 40 so that the resin film 40 passes through the oven 200 with respective edges 41 and 42 thereof being held by the outside grippers 110R and the inside grippers 110L.

Specifically, the outside grippers 110R hold one edge 41 of the resin film 40 and the inside grippers 110L hold the other edge 42 of the resin film 40. Then, the resin film 40 whose edges 41 and 42 are held is conveyed as the outside grippers 110R and the inside grippers 110L run, and enters the oven 200.

Once the resin film 40 enters the oven 200, the resin film 40 enters the preheating zone 210 of the oven 200 as the outside grippers 110R and the inside grippers 110L run. In the preheating zone 210, the step of heating the resin film 40 to a specific preheating temperature is performed. Usually, the preheating temperature of the resin film 40 is a temperature higher than an ordinary temperature. Specifically, the preheating temperature is preferably 40° C. or higher, more preferably (Tg+5)° C. or higher, and particularly preferably (Tg+15)° C. or higher, and is preferably (Tg+50)° C. or lower, more preferably (Tg+30)° C. or lower, and particularly preferably (Tg+20)° C. or lower. Preheating at such a temperature enables molecules included in the resin film 40 to be oriented in a stable manner by stretching.

After passing through the preheating zone 210, the resin film 40 enters the stretching zone 220 of the oven 200 and is conveyed as the outside grippers 110R and the inside grippers 110L run. In the stretching zone 220, the distance between the outside grippers 110R and the inside grippers 110L becomes wider as moving in a downstream direction. Accordingly, in this stretching zone 220, the step of stretching the resin film 40 by the outside grippers 110R and the inside grippers 110L is performed.

In the stretching zone 220, the outside grippers 110R and the inside grippers 110L run in such a manner that the moving direction of the resin film 40 is bent leftward. Thus, the outside grippers 110R and the inside grippers 110L, which opposed to each other in the perpendicular direction to the moving direction of the resin film 40 at the inlet 130 of the tenter stretching unit 100, run along the guide rails 120R and 120L having an asymmetrical shape in the stretching zone 220. As a result, the inside grippers 110L precede the outside grippers 110R in the heat setting zone 230 downstream of the stretching zone 220 (see the broken lines L_{D1}, L_{D2}, and L_{D3} in FIG. 2). Accordingly, in the stretching zone 220, stretching is performed in a diagonal direction relative to the width direction of the obtained stretched film 20.

The stretching ratio for this stretching is preferably 1.1 times or more, more preferably 1.2 times or more, and particularly preferably 1.3 times or more, and is preferably 3.0 times or less, more preferably 2.5 times or less, and particularly preferably 2.0 times or less. When the stretching ratio is equal to or more than the lower limit value of the aforementioned range, the degree and direction of molecular orientation of the stretched film 20 can be controlled particularly accurately. On the other hand, when the stretching ratio is equal to or less than the upper limit value of the aforementioned range, rupture of a film can be suppressed and a long-length film having a slow axis in a diagonal direction can be obtained in a stable manner.

The stretching temperature is preferably (Tg+3)° C. or higher, more preferably (Tg+5)° C. or higher, and particularly preferably (Tg+8)° C. or higher, and is preferably (Tg+15)° C. or lower, more preferably (Tg+14)° C. or lower, and particularly preferably (Tg+13)° C. or lower. When stretching is performed at such a temperature, the molecules included in the resin film 40 are allowed to be oriented in a stable manner by stretching and therefore a diagonally-stretched film 20 having a desired retardation can be obtained.

After passing through the stretching zone 220, the resin film 40 enters the heat setting zone 230 of the oven 200. In the heat setting zone 230, the conveyed resin film 40 is continuously cut with the trimming knives 310 and 320 of the trimming unit 300. As a result of this, both edges 41 and 42 of the resin film 40 are trimmed off. Therefore, in the heat setting zone 230, the step of releasing the remaining resin film 43 from the outside grippers 110R and the inside grippers 110L is performed by the trimming unit 300.

The remaining resin film 43 released from the outside grippers 110R and the inside grippers 110L is no longer affected by restraining force from the outside grippers 110R and the inside grippers 110L. However, a take-up force from the take-up unit 500 acts on the remaining resin film 43. Therefore, the remaining resin film 43 is taken up by this take-up unit 500, so as to be conveyed to the downstream. The remaining resin film 43 thus conveyed is subjected to a heat treatment at a specific heat treatment temperature in the area 232 downstream of the trimming unit 300 in the heat setting zone 230.

The heat treatment temperature is usually a temperature higher than (Tg−10)° C., preferably higher than (Tg−9)° C., and more preferably higher than (Tg−8)° C., and furthermore is usually a temperature lower than Tg, preferably lower than (Tg−3)° C., and more preferably lower than (Tg−5)° C. Thermal shrinkage in the slow axis direction of the stretched film 20 thus manufactured can be suppressed by conveying the remaining resin film 43 under such a heat treatment temperature in a state where it is released from the outside grippers 110R and the inside grippers 110L. In particular, the manufacturing method according to this embodiment can provide an advantage over a prior art method in that the manufactured resin film has a slow axis in a diagonal direction and thermal shrinkage in the slow axis direction can be effectively suppressed.

The treatment time of the aforementioned heat treatment is usually 10 seconds or more, preferably 15 seconds or more, and more preferably 20 seconds or more, and is preferably 50 seconds or less, more preferably 40 seconds or less, and particularly preferably 30 seconds or less. “Treatment time of heat treatment” herein refers to the duration for keeping the remaining resin film 43 under the aforementioned heat treatment temperature environment. When the treatment time is equal to or more than the lower limit value of the aforementioned range, thermal shrinkage of the stretched film 20 can be effectively suppressed. On the other hand, when the treatment time is equal to or less than the upper limit value of the aforementioned range, a favorable planarity of the stretched film 20 can be achieved and generation of wrinkles can be suppressed.

The conveyance tension for the remaining resin film 43 in the heat treatment step is preferably 100 N/cm² or more, more preferably 110 N/cm² or more, and particularly preferably 120 N/cm² or more, and is preferably 300 N/cm² or less, more preferably 200 N/cm² or less, and particularly preferably 180 N/cm² or less. The conveyance tension herein refers to a tension in the longitudinal direction applied to the remaining resin film 43 to be conveyed. The unit “N/cm²” of the aforementioned conveyance tension represents a tension per unit area of the remaining resin film 43 when viewed in the thickness direction. When the aforementioned conveyance tension is equal to or more than the lower limit value of the aforementioned range, generation of wrinkles and creases during conveyance can be suppressed. On the other hand, when the aforementioned conveyance tension is equal to or less than the upper limit value of the aforementioned range, thermal shrinkage in the conveying direction of the film can be effectively suppressed. The aforementioned conveyance tension may be controlled by the take-up force of the take-up unit 500.

As described above, the remaining resin film 43 is subjected to the heat treatment in the heat setting zone 230 and thereby thermal shrinkage of the remaining resin film 43 is suppressed and a desired stretched film 20 is obtained. The stretched film 20 thus obtained is taken up by the take-up unit 500 and delivered outside of the oven 200. Then, the stretched film 20 passes through the take-up unit 500 and is wound up and collected as a film roll 50.

On the other hand, the edges 41 and 42 trimmed off from the resin film 40 are conveyed through the heat setting zone 230 and then delivered outside of the oven 200. Then, once the edges are conveyed up to the outlet 140 of the tenter unit 100, the edges are released from the outside grippers 110R and the inside grippers 110L and then delivered to the conveying roll 400. Subsequently, as shown in FIG. 3, these edges 41 and 42 are guided to a place different from the place for the remaining resin film 43 by the conveying roll 400 and collected there.

As described above, the long-length stretched film 20 which was formed from the same resin as the resin film 40 before stretching can be manufactured by the manufacturing method according to this embodiment. In this embodiment, an unstretched film is used as the resin film 40, and therefore the manufactured stretched film 20 turns out to be a uniaxially stretched film which was stretched in one direction which is a diagonal direction relative to the width direction.

In the stretched film 20, molecules in the stretched film 20 are oriented in the stretching direction. Therefore, the stretched film 20 usually has a slow axis parallel or perpendicular to the diagonal direction, which is the stretching direction. Therefore, a stretched film having a slow axis in a diagonal direction can be manufactured by the aforementioned manufacturing method.

Generally, large thermal shrinkage occurs in the stretching direction in a stretched film. Therefore, a stretched film having a slow axis in a diagonal direction usually tends to cause large thermal shrinkage in the diagonal direction. It has been difficult so far to suppress thermal shrinkage in the diagonal direction of a long-length stretched film, and therefore a stretched film having a slow axis in the diagonal direction used to tend to cause large thermal shrinkage. In contrast to this, the aforementioned manufacturing method can suppress thermal shrinkage of the stretched film 20 even though the stretched film 20 has a slow axis in the diagonal direction. In particular, in the stretched film 20 manufactured by the aforementioned manufacturing method, thermal shrinkage can be suppressed effectively in the slow axis direction. Furthermore, the aforementioned manufacturing method usually allows for not only suppression of thermal shrinkage but also improvement in planarity. Accordingly, in the diagonally-stretched film 20 manufactured by the aforementioned manufacturing method, generation of wrinkles can be suppressed during conveying and winding up.

Furthermore, a stretched film generally exhibits a retardation and therefore the stretched film can be used as a phase difference film. In that case, when it is desired to decrease the thickness of the stretched film without changing the value of retardation, the stretching ratio is required to be increased. However, thermal shrinkage tends to increase with an increasing stretching ratio. Therefore, it has been particularly difficult so far to reduce the thickness of a stretched film having a slow axis in the diagonal direction when the stretched film is used as a phase difference film. In contrast to this, the aforementioned manufacturing method can effectively suppress thermal shrinkage in the diagonal direction of the stretched film 20 having a slow axis in the diagonal direction. Therefore, a thin phase difference film can be manufactured easily while suppressing thermal shrinkage by the aforementioned manufacturing method.

### 2. Second Embodiment

In the first embodiment described above, the resin film 40 was released from the grippers 110R and 110L by trimming off the edges 41 and 42 of the resin film 40 by the trimming unit 300. However, the manner of releasing the resin film from the grippers is not limited to that of the first embodiment. Hereinbelow, another manner of releasing the resin film from the grippers will be described by illustrating a second embodiment.

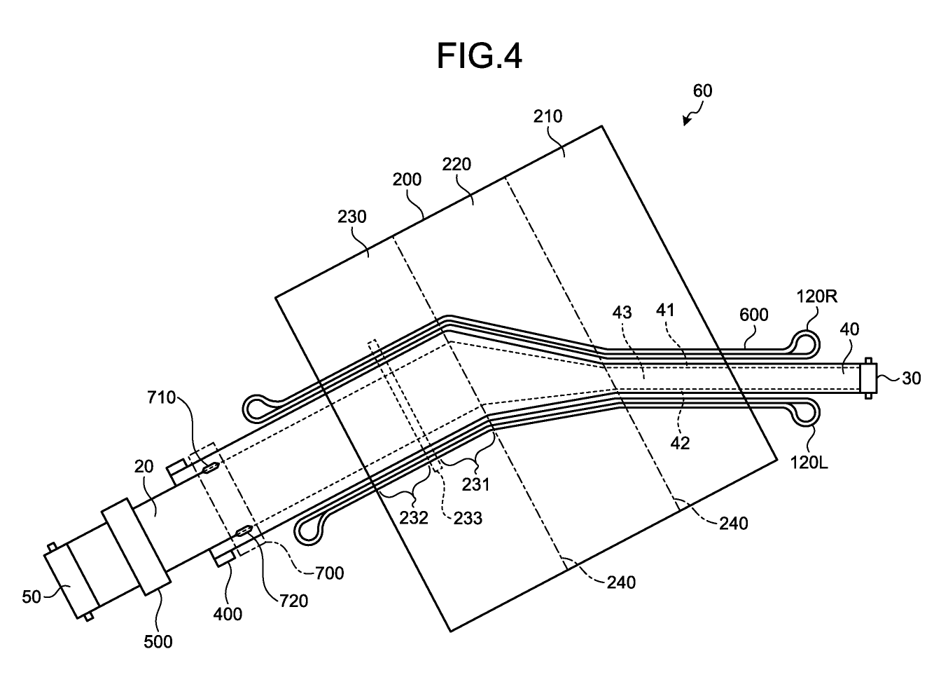

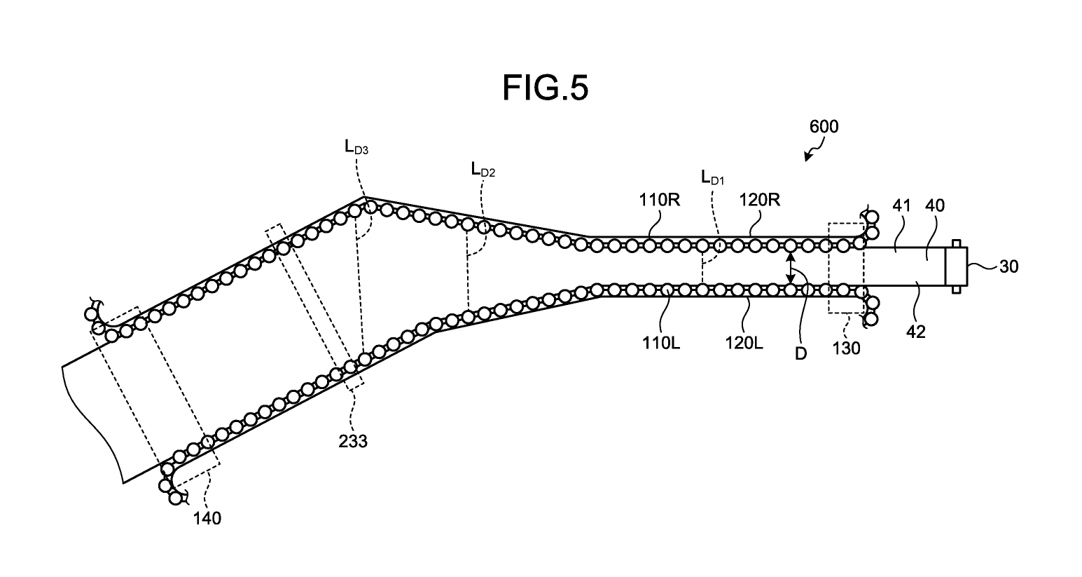

FIG. 4 is a plan view schematically showing an apparatus 60 for manufacturing a stretched film 20 according to the second embodiment of the present invention. In FIG. 4, an outside grippers 110R and an inside grippers 110L in a tenter unit 600 are not shown. FIG. 5 is a plan view schematically showing the tenter unit 600 according to the second embodiment of the present invention. In these FIGS. 4 and 5, members that are the same as those shown in FIGS. 1 to 3 are denoted by the same reference numerals as those in FIGS. 1 to 3.

As shown in FIGS. 4 and 5, the apparatus 60 for manufacturing the stretched film 20 according to the second embodiment of the present invention is the same as the manufacturing apparatus 10 according to the first embodiment, except that the manufacturing apparatus 60 includes a tenter unit 600 serving as a stretching unit in place of the tenter unit 100 and a trimming unit 700 in place of the trimming unit 300. Thus, this manufacturing apparatus 60 includes the tenter unit 600 serving as the stretching unit, an oven 200 serving as a temperature control unit, the trimming unit 700, a conveying roll 400, and a take-up unit 500 serving as a tension control device. This manufacturing apparatus 60 is configured to be able to manufacture the stretched film 20 by feeding a resin film 40 from a feeding roll 30 and stretching the fed resin film 40 in the oven 200 by the tenter unit 600.

The tenter unit 600 has the same configuration as that of the tenter unit 100 according to the first embodiment, except that the outside grippers 110R and the inside grippers 110L are provided in such a manner that the grippers can release the resin film 40 not at an outlet 140 of the tenter unit 600 but at a releasing position 233 set within a heat setting zone 230 of the oven 200. Therefore, the tenter unit 600 has a configuration in which the outside grippers 110R and the inside grippers 110L release respective edges 41 and 42 of the resin film 40 which the grippers had held and thereby the resin film 40 can be released from the outside grippers 110R and the inside grippers 110L within the heat setting zone 230.

Furthermore, the trimming unit 700 is provided in the same manner as the trimming unit 300 according to the first embodiment except that the trimming unit 700 is disposed between the oven 200 and the conveying roll 400. Therefore, the trimming unit 700 has a configuration in which the edges 41 and 42 of the resin film 40 can be removed by trimming knives 710 and 720 at a position downstream of the oven 200 and upstream of the conveying roll 400.

When the stretched film 20 is manufactured by using the aforementioned manufacturing apparatus 60, a manufacturing method described below is performed while conveying the resin film 40 so as to pass through the oven 200.

In this manufacturing method, as with the manufacturing method according to the first embodiment, the long-length resin film 40 is fed from the feeding roll 30 and the fed resin film 40 is continuously supplied to the tenter unit 600. The tenter unit 600 performs the step of sequentially holding respective edges 41 and 42 of the resin film 40 by the outside grippers 110R and the inside grippers 110L at an inlet 130 of the tenter unit 600. Then, the resin film 40 is conveyed so that the resin film enters the oven 200 and passes through a preheating zone 210 and a stretching zone 220, with respective edges 41 and 42 being held by the outside grippers 110R and the inside grippers 110L. Then, in the stretching zone 220, the step of stretching the resin film 40 by the outside grippers 110R and the inside grippers 110L is performed.

After passing through the stretching zone 220, the resin film 40 enters the heat setting zone 230 of the oven 200. Once the resin film 40 is conveyed up to the releasing position 233 in the heat setting zone 230, the outside grippers 110R and the inside grippers 110L release respective edges 41 and 42 of the resin film 40. In this manner, in the heat setting zone 230, the step of releasing the resin film 40 from the outside grippers 110R and the inside grippers 110L is performed.

Subsequently, the resin film 40 released from the outside grippers 110R and the inside grippers 110L is conveyed to the downstream. Then, the resin film 40 thus conveyed is subjected to a heat-treating process at a specific heat treatment temperature while being conveyed through the heat setting zone 230. The conditions for this heat treatment may be the same as that for the first embodiment. Such a heat treatment suppresses thermal shrinkage of the resin film 40.

Then, the heat-treated resin film 40 is delivered outside of the oven 200. The resin film 40 delivered outside of the oven 200 as it is may be collected as a stretched film because thermal shrinkage is suppressed by heat treatment. However, both edges 41 and 42 of the resin film 40 may possibly be damaged because the edges were held by the outside grippers 110R and the inside grippers 110L. Therefore, it is preferable to trim off both edges 41 and 42 from the resin film 40 and collect a film corresponding to a remaining middle part 43 as the stretched film 20. In this embodiment, both edges 41 and 42 of the heat-treated resin film 40 are trimmed off by the trimming unit 700 and the film corresponding to the remaining middle part 43 is collected as the stretched film 20.

Such a manufacturing method according to the second embodiment, as with the manufacturing method according to the first embodiment, allows for manufacture of the stretched film 20 with thermal shrinkage suppressed. Furthermore, the manufacturing method according to the second embodiment can usually provide an advantage that is the same as that of the manufacturing method according to the first embodiment.

[3. Modifications]

The method for manufacturing a stretched film of the present invention is not limited to the aforementioned embodiments and may be further modified for implementation.

For example, a film which had been subjected to a stretching process may be used as a resin film 40 in place of an unstretched film which had not been subjected to a stretching process. In this regard, examples of a method to be used for stretching the resin film 40 before the film is subjected to the manufacturing method according to the aforementioned embodiments may include a lengthwise stretching method using a roll method or a float method, and a lateral stretching method using a tenter stretching unit. Among these, the lengthwise stretching method using a float method is favorable for maintaining uniformity of the thickness and optical characteristics of the film.

Furthermore, the stretching direction in the tenter unit may be a width direction as far as a stretched film having a slow axis in a diagonal direction can be manufactured. For example, a stretched film which was subjected to a process of stretching the film in a diagonal direction may be used as the resin film 40 and be stretched in the width direction in the tenter unit to manufacture a stretched film having a slow axis in the diagonal direction. Also in such a stretched film, it is possible to suppress thermal shrinkage in the slow axis direction diagonal to the width direction.

[4. Stretched Film]

With the aforementioned manufacturing method, it is possible to obtain a long-length stretched film which has a slow axis in a diagonal direction wherein thermal shrinkage in the slow axis direction is effectively suppressed. Hereinbelow, this stretched film will be described.

This stretched film is a long-length film which is formed of the same resin as that of the resin film prior to stretching and has the slow axis in the diagonal direction thereof. Specifically, the stretched film has the slow axis within an average angle range of 10° or more and 80° or less with respect to the width direction thereof. That a film has a slow axis within a certain average angle range with respect to the width direction thereof herein means that when the angles formed by the width direction and the slow axis of the film are measured at a plurality of positions in the width direction of the film, the average of the angles measured at those positions falls within the certain angle range. The angle formed by the width direction and the slow axis of the film may be appropriately referred to hereinbelow as “orientation angle”. Furthermore, the average of the aforementioned orientation angles may be appropriately referred to hereinbelow as “average orientation angle”. The average orientation angle of the stretched film is usually 10° or more, preferably 20° or more, and more preferably 30° or more, and is usually 80° or less, preferably 70° or less, and more preferably 60° or less. A slow axis is usually generated by stretching a resin film in a diagonal direction. Therefore, a specific value of the aforementioned average orientation angle can be adjusted by stretching conditions for the aforementioned manufacturing method.

Furthermore, this stretched film has a small thermal shrinkage rate in the slow axis direction of the stretched film. Therefore, when the stretched film is kept at Tg−18° C. for one hour, the thermal shrinkage rate in the slow axis direction of the stretched film can be kept within a certain narrow range. The specific range of this thermal shrinkage rate is usually 0.1% to 0.3%, preferably 0.1% to 0.27%, and more preferably 0.1% to 0.25%. Tg herein represents a glass transition temperature of a resin which forms the stretched film. As the thermal shrinkage rate in the slow axis direction can be kept at such a low value, this stretched film and any film obtained from this stretched film have favorable size stability in a high-temperature environment.

The thermal shrinkage rate in the slow axis direction of the stretched film may be measured by a method described below.

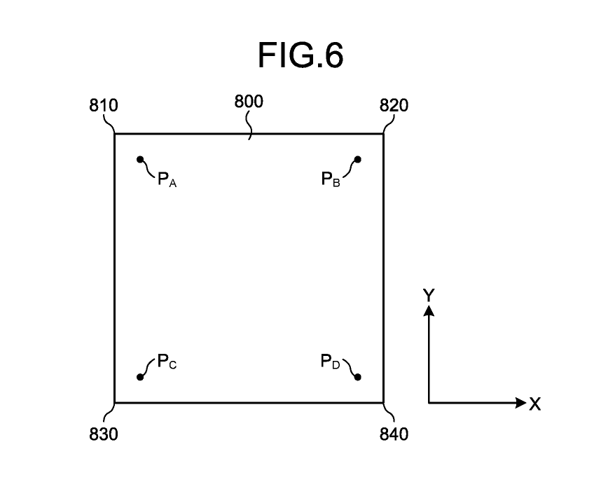

FIG. 6 is a plan view schematically showing a test piece 800 used for measuring the thermal shrinkage rate. As shown in FIG. 6, the square test piece 800 is cut out of the long-length stretched film, the square test piece 800 having a side parallel to the slow axis direction of the stretched film and a side perpendicular to the aforementioned slow axis direction. In FIG. 6, a direction X is parallel to the slow axis direction of the stretched film and a direction Y is perpendicular to the slow axis direction of the stretched film. In this case, the length of a side of the test piece 800 is set at 120 mm. Three test pieces 800 are cut out in total: one piece each from a middle part and both edge parts in the width direction of the stretched film.

Four marked points P_{A}, P_{B}, P_{C}, and P_{D} are set in the vicinity of apexes 810, 820, 830, and 840 of the cut test piece 800, in which the distance between each marked point and each of two sides adjacent at the corresponding apex is 10 mm. At this time, all of the distance between the marked points P_{A} and P_{B}, the distance between the marked points P_{A} and P_{C}, the distance between the marked points P_{B} and P_{D}, and the distance between the marked points P_{C} and P_{D} are 100 mm. This test piece 800 is kept at a measurement temperature of Tg−18° C. for one hour.

Then, the distance D_{AB} between the marked point P_{A} and the marked point P_{B} which are located in parallel to the slow axis direction is measured, and ΔD_{AB} (=100 mm−D_{AB}), which is a displacement relative to the distance before the keeping (100 mm), is calculated. The distance D_{C}D between the marked point P_{C} and the marked point P_{D} which are the other marked points located in parallel to the slow axis direction is also measured, and ΔD_{CD} (=100 mm−D_{CD}), which is a displacement relative to the distance before the keeping (100 mm), is calculated.

The size change rate ΔL of each test piece is calculated from these displacements ΔD_{AB} and ΔD_{CD} by using the following formula. Unit of the displacement ΔD_{AB} and the displacement ΔD_{CD} herein is millimeters.

ΔL={(ΔD_{AB}/100)+(ΔD_{CD}/100)}/2×100(%)

Then, the average of size change rates ΔL of the test pieces 800 from the middle part and both edge parts is calculated and the average is adopted as a thermal shrinkage rate in the slow axis direction of the stretched film.

Furthermore, this stretched film usually has excellent planarity. Consequently, generation of wrinkles can be suppressed during conveyance and winding up of the stretched film in the manufacturing process thereof. Therefore, the aforementioned stretched film usually has no wrinkles.

Furthermore, this stretched film usually has a retardation resulting from stretching. The average in-plane retardation of the stretched film is preferably 50 nm or more, more preferably 60 nm or more, and particularly preferably 70 nm or more, and preferably 300 nm or less, more preferably 290 nm or less, and particularly preferably 280 nm or less. When a stretched film has an average in-plane retardation within such a range, a film cut out of the stretched film can be suitably used as an optical film for a variety of applications.

The average in-plane retardation of the stretched film may be determined by measuring an in-plane retardation at a plurality of points located at 50 mm intervals in the width direction of the stretched film and calculating the average of the in-plane retardation values measured at these points.

The fluctuation in in-plane retardation of the stretched film is preferably 10 nm or less, more preferably 5 nm or less, particularly preferably 2 nm or less, and ideally 0 nm. The fluctuation in in-plane retardation herein refers to the difference between the maximum value and the minimum value of in-plane retardation at any point of the stretched film. When a film cut out of a stretched film is applied to a display device, image quality of the display device can be made favorable by keeping the fluctuation in in-plane retardation of the stretched film small as described above.

The fluctuation in the orientation angle of the stretched film is preferably 1.0° or less, more preferably 0.5° or less, particularly preferably 0.3° or less, and ideally 0° in the longitudinal direction of the stretched film. The aforementioned fluctuation in the orientation angle herein refers to the difference between the maximum value and the minimum value of the aforementioned orientation angle of the stretched film. When a film cut out of a stretched film is used as an optical compensation film of a liquid crystal display device, contrast of the liquid crystal display device can be improved by keeping the aforementioned fluctuation in the orientation angle of the stretched film small as described above.

The total light transmittance of the stretched film is preferably 80% or more, more preferably 85% or more, and particularly preferably 90% or more. Light transmittance may be measured using a spectrophotometer (a ultraviolet-visible-near infrared spectrophotometer “V-570” manufactured by JASCO Corporation) in accordance with JIS K0115.

The haze of the stretched film is preferably 5% or less, more preferably 3% or less, particularly preferably 1% or less, and ideally 0%. As described herein, haze is measured in five areas using “a turbidimeter NDH-300A” manufactured by Nippon Denshoku Industries Co., Ltd. in accordance with JIS K7361-1997 and the average of those measurements may be adopted.

The amount of a volatile component contained in the stretched film is preferably 0.1% by weight or less, more preferably 0.05% by weight or less, even more preferably 0.02% by weight or less, and ideally zero. Reduction of the amount of the volatile component can improve size stability of the stretched film, thereby reducing change over the lapse of time in optical property characteristics such as in-plane retardation.

A volatile component herein refers to a substance with a molecular weight of 200 or less contained in the film in a trace amount. Examples of the volatile component may include a residual monomer and a solvent. The amount of the volatile component, which represents a total of the substances with a molecular weight of 200 or less contained in the film, may be quantified by dissolving the film in chloroform and analyzing the dissolved film by gas chromatography.

The saturated water absorption ratio of the stretched film is preferably 0.03% by weight or less, more preferably 0.02% by weight or less, particularly preferably 0.01% by weight or less, and ideally zero. When the saturated water absorption ratio of the stretched film falls within the aforementioned range, change over the lapse of time in optical characteristics such as in-plane retardation of the stretched film can be reduced.

As described herein, a saturated water absorption ratio is a value expressed as a percentage of increase in weight of a film test piece relative to the weight of the film test piece prior to immersion when the test piece cut out of a stretched film was immersed in water at 23° C. for 24 hours.

The thickness of the stretched film is preferably 10 μm or more, more preferably 15 μm or more, and particularly preferably 20 μm or more, and is preferably 50 μm or less, more preferably 45 μm or less, and particularly preferably 20 μm or less. When the thickness of the stretched film falls within such a range, mechanical strength of the stretched film can be enhanced. Generally, it has been difficult to achieve all of a large retardation, thin thickness, and suppressed thermal shrinkage in a prior art stretched film having a slow axis in a diagonal direction. In contrast to this, even when the aforementioned stretched film of the present invention has a large retardation, it is possible to make the thickness of the stretched film thin as described above while suppressing its thermal shrinkage.

The width of the stretched film is preferably 1000 mm or more, more preferably 1300 mm or more, and particularly preferably 1330 mm or more, and is preferably 1500 mm or less, and more preferably 1490 mm or less. By having such a wide width, the stretched film can be applied to a large-sized display device (for example, an organic electroluminescence display device).

There is no limitation to the application of the aforementioned stretched film. The stretched film may be used as an optical film, for example, alone or in combination with other members. Examples of such an optical film may include a substrate film for forming an optional layer on the substrate film; and a phase difference film such as a polarizing plate protective film, a viewing angle compensation film for a liquid crystal display device, and a ¼ wave plate to be provided to a circularly polarizing plate.

Among others, from the viewpoint of taking advantage of the property of the stretched film having suppressed thermal shrinkage, the stretched film is preferably used as a substrate film, and particularly preferably is used as a substrate film for a touch panel. When a conductive layer, such as an electrode layer, a wiring layer, and a terminal layer, is formed on the substrate film for a touch panel, the conductive layer is often formed by a film formation method such as a vapor deposition method, a sputtering method, an ion plating method, an ion beam-assisted vapor deposition method, an arc discharge plasma vapor deposition method, a heat CVD method, or a plasma CVD method. However, these film formation methods are generally performed in a high-temperature environment. A prior art stretched film, in which thermal shrinkage was not sufficiently suppressed, causes size change due to thermal shrinkage when the film formation methods as described above is used, and it has been difficult to form a conductive layer in an appropriate position. In contrast to this, when the aforementioned stretched film having suppressed thermal shrinkage is used as a substrate film, a conductive layer can be formed while suppressing size change due to thermal shrinkage and therefore it is possible to form the conductive layer in an appropriate position.

### EXAMPLES

[Evaluation Method]

[Method for Measuring Average in-Plane Retardation of Stretched Film]

A phase difference-measuring device (“KOBRA-21ADH” manufactured by Oji Scientific Instruments) was used to measure an in-plane retardation at a plurality of points located at 50 mm intervals in the width direction of the stretched film. The average of the in-plane retardation values at these points was calculated and this average was adopted as an average in-plane retardation of the stretched film of interest. For this measurement, the measuring wavelength was 590 nm.

[Method for Measuring Average Orientation Angle of Stretched Film]

A polarization microscope (“BX51” manufactured by Olympus Corporation) was used to observe an in-plane slow axis at a plurality of points located at 50 mm intervals in the width direction of the stretched film and determine the orientation angle formed between the slow axis and the width direction of the stretched film. The average of the orientation angles at these points was calculated and this average was adopted as an average orientation angle of the stretched film of interest.

[Method for Measuring Thermal Shrinkage Rate of Film]

A measurement direction in which a thermal shrinkage rate was intended to be measured was selected from the longitudinal direction, the width direction, the slow axis direction, and the fast axis direction of the stretched film. Then, as shown in FIG. 6, a square test piece 800 was cut out of the stretched film, the square test piece 800 having sides parallel to the measurement direction of the stretched film and sides perpendicular to the aforementioned measurement direction. In FIG. 6, a direction X is parallel to the measurement direction of the stretched film and a direction Y is perpendicular to the measurement direction of the stretched film. In this case, the length of each side of the test piece 800 was set at 120 mm. Three test pieces 800 were cut out in total: one piece each from a middle part and both edge parts in the width direction of the stretched film.

Four marked points P_{A}, P_{B}, P_{C}, and P_{D} were set in the vicinity of apexes 810, 820, 830, and 840 of the cut out test piece 800, in which the distance between each marked point and each of two sides adjacent at the corresponding apex was 10 mm. At this time, all of the distance between the marked points P_{A} and P_{B}, the distance between the marked points P_{A} and P_{C}, the distance between the marked points P_{B} and P_{D}, and the distance between the marked points P_{C} and P_{D} were 100 mm. This test piece 800 was kept at a measurement temperature of Tg−18° C. for one hour.

Then, the distance D_{AB} between the marked point P_{A} and the marked point P_{B} which were located in parallel to the measurement direction was measured, and ΔD_{AB} (=100 mm−D_{AB}), which was a displacement relative to the distance before the keeping (100 mm), was calculated. The distance D_{C}D between the marked point P_{C} and the marked point P_{D} which were the other marked points located in parallel to the measurement direction was also measured, and ΔD_{CD} (=100 mm−D_{CD}), which was a displacement from the distance before the keeping (100 mm), was calculated.

The size change rate ΔL of each test piece in the measurement direction was calculated from these displacements ΔD_{AB} and ΔD_{CD} using the following formula. Unit of the displacement ΔD_{AB} and the displacement ΔD_{CD} herein is millimeters.

ΔL={(ΔD_{AB}/100)+(ΔD_{CD}/100)}/2×100(%)

Then, the average of size change rates ΔL of the test pieces 800 from the middle part and both edge parts was calculated and the average was adopted as a thermal shrinkage rate in the measurement direction of the stretched film.

For this measurement of distances between the marked points P_{A}, P_{B}, P_{C}, and P_{D}, a universal projector (“V-12B” manufactured by Nikon Corporation) was used.

[Method for Evaluating Planarity of Stretched Film]

Planarity of the stretched film was evaluated by visually observing the stretched film and determining the presence or absence of a wrinkle. A film in which no wrinkle was observed was evaluated as “good”, a film in which a few wrinkles were observed was evaluated as “acceptable”, and a film in which wrinkles were generated to cause bending of the film was evaluated as “unacceptable”.

### Example 1

A long-length resin film having a thickness of 50 μm was manufactured by molding a norbornene resin (“ZEONOR1600” manufactured by ZEON Corporation; glass transition temperature: 163° C.) by a T-die film extruder and was wound up into a roll form.

An apparatus 10 for manufacturing a stretched film which had a configuration described in the first embodiment as shown in FIGS. 1 to 3 was prepared. A resin film 40 formed of the norbornene resin drawn out from a roll 30 was supplied to a tenter unit 100 of this manufacturing apparatus 10. The supplied resin film 40 was held at respective edges 41 and 42 by outside grippers 110R and inside grippers 110L and conveyed through a preheating zone 210 within an oven 200. Preheating treatment in the preheating zone 210 was performed at 177° C. Then, the resin film 40 was transferred to a stretching zone 220 and stretched in a diagonal direction in the stretching zone 220. The stretching conditions were a stretching ratio of 1.5 and a stretching temperature of 175.5° C. Subsequently, both edges 41 and 42 of the stretched resin film 40 were trimmed off in a heat setting zone 230 by a trimming unit 300 disposed immediately downstream of the stretching zone 220 to release a remaining resin film 43 from the outside grippers 110R and the inside grippers 110L. Then, this remaining resin film 43 was subjected to a heat treatment by passing it through the heat setting zone 230 to obtain a stretched film 20. The conditions for heat treatment were a heat treatment temperature (a temperature in the heat setting zone 230) of 155° C., a treatment time of 20 seconds, and a conveyance tension at heat treatment of 200 N/cm². The stretched film 20 thus obtained was delivered outside of the oven 200, and wound up and collected as a film roll 50.

The stretched film 20 thus obtained was evaluated by the aforementioned methods.

### Example 2

A stretched film was manufactured and evaluated in the same manner as that in Example 1 except that the heat treatment temperature in the heat setting zone was changed to 160° C.

### Example 3

A stretched film was manufactured and evaluated in the same manner as that in Example 1 except that the treatment time for the heat treatment in the heat setting zone was changed to 50 seconds.

### Example 4

A stretched film was manufactured and evaluated in the same manner as that in Example 1 except that the treatment time for the heat treatment in the heat setting zone was changed to 10 seconds.

### Example 5

A stretched film was manufactured and evaluated in the same manner as that in Example 1 except that the conveyance tension for the heat treatment in the heat setting zone was changed to 100 N/cm².

### Example 6

A stretched film was manufactured and evaluated in the same manner as that in Example 1 except that the conveyance tension for the heat treatment in the heat setting zone was changed to 120 N/cm².

### Example 7

A stretched film was manufactured and evaluated in the same manner as that in Example 1 except that the conveyance tension for the heat treatment in the heat setting zone was changed to 300 N/cm².

### Example 8

The resin for forming a stretched film was changed to a norbornene resin (“ZEONOR 1430” manufactured by ZEON Corporation; glass transition temperature: 136° C.) and the thickness of the resin film subjected to stretching was changed to 70 μm. Furthermore, in accordance with the change in the type of resin and the thickness of the film, the preheating temperature was changed to 148° C., the stretching temperature was changed to 146° C., and the heat treatment temperature was changed to 128° C. The stretched film was manufactured and evaluated in the same manner as that in Example 1 except for the aforementioned matters.

### Example 9

The resin for forming a stretched film was changed to a norbornene resin (manufactured by ZEON Corporation; glass transition temperature: 126° C.) and the thickness of the resin film subjected to stretching was changed to 69 μm. Furthermore, in accordance with the change in the type of resin and the thickness of the film, the preheating temperature was changed to 140° C., the stretching temperature was changed to 138° C., and the heat treatment temperature was changed to 118° C. The stretched film was manufactured and evaluated in the same manner as that in Example 1 except for the aforementioned matters.

### Example 10

A stretched film was manufactured and evaluated in the same manner as that in Example 1 except that the treatment time for the heat treatment in the heat setting zone was changed to 60 seconds.

### Comparative Example 1

A trimming unit 300 was moved downstream of an outlet 140 of a tenter unit 100. As a result of this, a resin film 40 after being stretched passed through a heat setting zone 230 with respective edges 41 and 42 being held by outside grippers 110R and inside grippers 110L, and both edges 41 and 42 were trimmed off downstream of an oven 200. Furthermore, the temperature in the heat setting zone 230 was changed to 140° C. The stretched film was manufactured and evaluated in the same manner as that in Example 1 except for the aforementioned matters.

### Comparative Example 2

A trimming unit 300 was moved downstream of an outlet 140 of a tenter unit 100. As a result of this, a resin film 40 after being stretched passed through a heat setting zone 230 with respective edges 41 and 42 being held by outside grippers 110R and inside grippers 110L, and both edges 41 and 42 were trimmed off downstream of an oven 200. The stretched film was manufactured and evaluated in the same manner as that in Example 1 except for the aforementioned matters.

### Comparative Example 3

A stretched film was manufactured and evaluated in the same manner as that in Example 1 except that the heat treatment temperature in the heat setting zone was changed to 150° C.

### Comparative Example 4

A stretched film was manufactured and evaluated in the same manner as that in Example 1 except that the heat treatment temperature in the heat setting zone was changed to 165° C. However, because a wrinkle had been generated on the obtained stretched film and the film was bent, the in-plane retardation and the thermal shrinkage rate could not be measured.

### Comparative Example 5

A stretched film was manufactured and evaluated in the same manner as that in Example 1 except that the treatment time for the heat treatment in the heat setting zone was changed to 5 seconds.

[Results]

The results of the aforementioned Examples are shown in Table 1 and the results of the aforementioned Comparative Examples are shown in Table 2. In the following tables, the meanings of abbreviations are as follows:

Released or not: whether the resin film was released from grippers in the heat setting zone or not

Tg: the glass transition temperature of the resin for forming the stretched film

Re: the average in-plane retardation of the stretched film

θ: the average orientation angle of the stretched film Thermal shrinkage rate/TD: the thermal shrinkage rate in the width direction of the stretched film

Thermal shrinkage/MD: the thermal shrinkage rate in the longitudinal direction of the stretched film

Thermal shrinkage rate/Slow: the thermal shrinkage rate in the slow axis direction of the stretched film

Thermal shrinkage/Fast: the thermal shrinkage rate in the fast axis direction of the stretched film

TABLE 1
[Results of Examples]

| | Example number | | | | | | | | | |
|---|---|---|---|---|---|---|---|---|---|---|
| | 1 | 2 | 3 | 4 | 5 | 6 | 7 | 8 | 9 | 10 |
| Released or not | Yes | Yes | Yes | Yes | Yes | Yes | Yes | Yes | Yes | Yes |
| Tg(° C.) | 163 | 163 | 163 | 163 | 163 | 163 | 163 | 136 | 126 | 163 |
| Heat treatment | 155 | 160 | 155 | 155 | 155 | 155 | 155 | 128 | 118 | 155 |
| temperature | | | | | | | | | | |
| (° C.) | | | | | | | | | | |
| Heat treatment | 20 | 20 | 50 | 10 | 20 | 20 | 20 | 20 | 20 | 60 |
| time (second) | | | | | | | | | | |
| Conveyance | 200 | 200 | 200 | 200 | 100 | 120 | 300 | 200 | 200 | 200 |
| tension (N/cm²) | | | | | | | | | | |
| Re(nm) | 90 | 89 | 70 | 140 | 90 | 90 | 90 | 140 | 140 | 80 |
| θ(°) | 45 | 45 | 45 | 45 | 45 | 45 | 45 | 45 | 45 | 45 |
| Thickness (μm) | 35 | 35 | 35 | 35 | 35 | 35 | 35 | 47 | 46 | 35 |
| Thermal | 145 | 145 | 145 | 145 | 145 | 145 | 145 | 118 | 108 | 145 |
| shrinkage | | | | | | | | | | |
| rate | | | | | | | | | | |
| measurement | | | | | | | | | | |
| temperature | | | | | | | | | | |
| (° C.) | | | | | | | | | | |
| Thermal | 0.04 | 0.04 | 0.03 | 0.05 | 0.04 | 0.02 | 0.05 | 0.05 | 0.02 | 0.02 |
| shrinkage | | | | | | | | | | |
| rate/TD(%) | | | | | | | | | | |
| Thermal | 0.22 | 0.24 | 0.25 | 0.2 | 0.15 | 0.17 | 0.30 | 0.13 | 0.12 | 0.29 |
| shrinkage | | | | | | | | | | |
| rate/MD(%) | | | | | | | | | | |
| Thermal | 0.28 | 0.26 | 0.23 | 0.29 | 0.23 | 0.23 | 0.25 | 0.18 | 0.17 | 0.21 |
| shrinkage | | | | | | | | | | |
| rate/Slow(%) | | | | | | | | | | |
| Thermal | −0.03 | 0.00 | −0.03 | −0.02 | −0.03 | −0.04 | −0.04 | 0.01 | −0.02 | 0.01 |
| shrinkage | | | | | | | | | | |
| rate/Fast(%) | | | | | | | | | | |
| Planarity | Good | Acceptable | Good | Good | Acceptable | Good | Acceptable | Good | Good | Acceptable |

TABLE 2
[Results of Comparative Examples]

| | Comparative Example number | | | | |
|---|---|---|---|---|---|
| | 1 | 2 | 3 | 4 | 5 |
| Released or not | No | No | Yes | Yes | Yes |
| Tg(° C.) | 163 | 163 | 163 | 163 | 163 |
| Heat treatment | 140 | 155 | 150 | 165 | 155 |
| temperature (° C.) | | | | | |
| Heat treatment | 20 | 20 | 20 | 20 | 5 |
| time (second) | | | | | |
| Conveyance | 200 | 200 | 200 | 200 | 200 |
| tension (N/cm²) | | | | | |
| Re(nm) | 90 | 90 | 90 | — | 110 |
| θ(°) | 45 | 45 | 45 | 45 | 45 |
| Thickness (μm) | 35 | 35 | 35 | 35 | 35 |
| Thermal shrinkage | 145 | 145 | 145 | — | 145 |
| rate measurement | | | | | |
| temperature (° C.) | | | | | |
| Thermal shrinkage | 0.10 | 0.08 | 0.05 | — | 0.13 |
| rate/TD(%) | | | | | |
| Thermal shrinkage | 0.16 | 0.26 | 0.22 | — | 0.2 |
| rate/MD(%) | | | | | |
| Thermal shrinkage | 0.48 | 0.46 | 0.33 | — | 0.38 |
| rate/Slow(%) | | | | | |
| Thermal shrinkage | −0.09 | −0.1 | −0.07 | — | −0.08 |
| rate/Fast(%) | | | | | |
| Planarity | Good | Good | Good | Unac- | Good |
| | | | | ceptable | |

### DISCUSSION

As can be seen from the aforementioned Examples, the manufacturing method of the present invention allows for manufacturing of a stretched film which has a slow axis in a diagonal direction, has excellent planarity, and has suppressed thermal shrinkage.

### REFERENCE SIGN LIST

10 apparatus for manufacturing stretched film
20 stretched film
30 feeding roll
40 resin film
41 edge of resin film
42 edge of resin film
43 middle part of resin film (remaining resin film)
50 film roll
60 apparatus for manufacturing a stretched film
100 tenter unit
110R outside gripper
110L inside gripper
120R guide rail
120L guide rail
130 inlet of tenter unit
140 outlet of tenter unit
200 oven
210 preheating zone
220 stretching zone
230 heat setting zone
231 area upstream of trimming unit in heat setting zone
232 area downstream of trimming unit in heat setting zone
233 releasing position
240 partition
300 trimming unit
310 trimming knife
320 trimming knife
400 conveying roll
500 take-up unit
510 take-up roll
520 take-up roll
600 tenter unit
700 trimming unit
710 trimming knife
720 trimming knife
800 test piece
810, 820, 830 and 840 apex of test piece

1. A method for manufacturing a stretched film, including stretching a long-length resin film in an oven by grippers holding both edges of the resin film while conveying the resin film to pass the resin film through the oven to manufacture a long-length stretched film having a slow axis within an average angle range of 10° or more and 80° or less with respect to a width direction thereof, wherein
the oven has a stretching zone and a heat setting zone in this order from an upstream side, and
the method comprises the steps of:
holding the both edges of the resin film by the grippers;
stretching the resin film in the stretching zone;
releasing the resin film from the grippers in the heat setting zone; and
subjecting the resin film released from the grippers to a heat treatment at a temperature higher than Tg−10° C. and lower than Tg (Tg represents a glass transition temperature of a resin for forming the resin film) for 10 seconds or more in the heat setting zone.

2. The method for manufacturing a stretched film according to claim 1, wherein a conveyance tension for the resin film in the step of subjecting the resin film to the heat treatment is 100 N/cm² or more and 300 N/cm² or less.

3. A long-length stretched film formed of a thermoplastic resin, wherein
the long-length stretched film has a slow axis within an average angle range of 10° or more and 80° or less with respect to a width direction of the stretched film, and
a thermal shrinkage rate in a direction of the slow axis when the stretched film is kept at Tg−18° C. (Tg represents a glass transition temperature of the thermoplastic resin) for one hour is 0.1% to 0.3%.

4. The long-length stretched film according to claim 3, having a thickness of 10 μm to 50 μm.
